(19) United States
(12) Patent Application Publication
(10) Pub. No.: US 2007/0235594 A1
(43) Pub. Date: Oct. 11, 2007

(54) Pilot flight control stick feedback system

(75) Inventors: Paul T. Wingett, Mesa, AZ (US); Calvin C. Potter, Mesa, AZ (US); Casey Hanlon, Queen Creek, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/400,251

(22) Filed: Apr. 6, 2006

(51) Int. Cl. B64C 13/46

(52) U.S. Cl. 244/223

(57) ABSTRACT

A pilot flight control stick haptic feedback mechanism provides variable force feedback to the pilot flight control stick based on actual aircraft conditions. The flight control stick is movable to a control position in a displacement direction. A control unit receives one or more signals representative of aircraft conditions and, in response thereto, selectively supplies a variable force feedback signal. A magnetic bearing is disposed adjacent at least a portion of the flight control stick, and is responsive to the variable force feedback signal to supply a variable magnetic feedback force to the flight control stick in a direction that opposes the displacement direction.

### TECHNICAL FIELD

The present invention relates to flight control sticks and, more particularly, to a pilot flight control stick feedback system that supplies haptic feedback to the pilot.

### BACKGROUND

Aircraft typically include a plurality of flight control surfaces that, when controllably positioned, guide the movement of the aircraft from one destination to another. The number and type of flight control surfaces included in an aircraft may vary, but typically include both primary flight control surfaces and secondary flight control surfaces. The primary flight control surfaces are those that are used to control aircraft movement in the pitch, yaw, and roll axes, and the secondary flight control surfaces are those that are used to influence the lift or drag (or both) of the aircraft. Although some aircraft may include additional control surfaces, the primary flight control surfaces typically include a pair of elevators, a rudder, and a pair of ailerons, and the secondary flight control surfaces typically include a plurality of flaps, slats, and spoilers.

The positions of the aircraft flight control surfaces are typically controlled using a flight control surface actuation system. The flight control surface actuation system, in response to position commands that originate from either the flight crew or an aircraft autopilot, moves the aircraft flight control surfaces to the commanded positions. In most instances, this movement is effected via actuators that are coupled to the flight control surfaces.

Typically, the position commands that originate from the flight crew are supplied via some type of input control mechanism. For example, many aircraft include two yoke and wheel type of mechanisms, one for the pilot and one for the co-pilot. Either mechanism can be used to generate desired flight control surface position commands. More recently, however, aircraft are being implemented with side stick type mechanisms. Most notably in aircraft that employ a fly-by-wire system. Similar to the traditional yoke and wheel mechanisms, it is common to include multiple side sticks in the cockpit, one for the pilot and one for the co-pilot. Most side sticks are implemented with some type of mechanism for providing force feedback (or “haptic feedback”) to the user, be it the pilot or the co-pilot. In some implementations, one or more orthogonally arranged springs are used to provide force feedback. In other implementations, one or more electric motors are used to supply the force feedback.

Although the above-described force feedback mechanisms are generally safe and reliable, each does suffer certain drawbacks. For example, the feedback mechanisms may not provide variable force feedback based on actual aircraft conditions. Moreover, the electric motor implementations are usually provided in double or triple redundant arrangements, which can increase overall system size, weight, and costs.

Hence, there is a need for a pilot side stick feedback mechanism that provides variable force feedback based on actual aircraft conditions and/or that can be implemented with relatively lightweight and/or relatively inexpensive components. The present invention addresses one or more of these needs.

### BRIEF SUMMARY

The present invention provides a pilot flight control stick feedback mechanism that provides variable force feedback based on actual aircraft conditions. In one embodiment, and by way of example only, an aircraft flight control surface actuation haptic feedback system includes a flight control stick, a control unit, and a magnetic bearing. The flight control stick is adapted to receive an input force supplied by a pilot and is configured, upon receipt of the input force, to move at least a portion thereof to a control position in a displacement direction. The control unit is adapted to receive one or more signals representative of aircraft conditions and is operable, in response thereto, to selectively supply a variable force feedback signal. The magnetic bearing is disposed adjacent at least a portion of the flight control stick, is coupled to receive the variable force feedback signal, and is operable, in response thereto, to supply a variable magnetic feedback force to the flight control stick in a direction that opposes the displacement direction.

In another exemplary embodiment, an aircraft flight control surface actuation system includes a flight control stick, a control unit, and a magnetic bearing. The flight control stick is adapted to receive an input force supplied by a pilot and is configured, upon receipt of the input force, to move at least a portion thereof to a control position in a displacement direction, and to supply a flight control surface position control signal based at least in part on the control position to which the flight control stick is moved. The control unit is coupled to receive the flight control surface position control signal, and one or more signals representative of aircraft conditions, and is operable, in response thereto, to supply one or more flight control surface position commands, and supply a variable force feedback signal. The magnetic bearing is disposed adjacent to at least a portion of the flight control stick. The magnetic bearing is coupled to receive the variable force feedback signal and is operable, in response thereto, to supply a variable magnetic feedback force to the flight control stick in a direction that opposes the displacement direction.

In yet another exemplary embodiment, an aircraft flight control surface actuation system includes a flight control stick, one or more flight control stick position sensors, a control unit, and a magnetic bearing. The flight control stick is adapted to receive an input force supplied by a pilot and is configured, upon receipt of the input force, to move at least a portion thereof to a control position in a displacement direction. The flight control stick position sensors are configured to sense the control position of the flight control stick and are operable to supply a flight control surface position control signal based at least in part on the sensed control position. The control unit is coupled to receive the flight control surface position control signal, one or more signals representative of aircraft conditions, and a signal representative of aircraft operational envelope, and is operable, in response thereto, to supply one or more flight control surface position commands, and supply a variable force feedback signal. The magnetic bearing is disposed adjacent to at least a portion of the flight control stick. The magnetic bearing is coupled to receive the variable force feedback signal and is operable, in response thereto, to supply a variable magnetic feedback force to the flight control stick in a direction that opposes the displacement direction.

Other independent features and advantages of the preferred feedback mechanism will become apparent from the following detailed description, taken in conjunction with the. accompanying drawings which illustrate, by way of example, the principles of the invention.

### BRIEF DESCRIPTION OF THE DRAWINGS

FIG. 1 is a perspective view of an exemplary aircraft depicting primary and secondary flight control surfaces;

FIG. 2 is a schematic depicting portions of an exemplary flight control surface actuation system according one embodiment of the present invention;

FIG. 3 is a functional block diagram of the flight control surface actuation system of FIG. 2, depicting certain portions thereof in slightly more detail;

FIG. 4 is a perspective view of a simplified schematic representation of a portion of an exemplary flight control stick according to an embodiment of the present invention, and that may be used to implement the exemplary flight control surface actuation systems of FIGS. 2 and 3; and

FIG. 5 is a side view of a simplified schematic representation of a portion of an exemplary flight control stick according to an alternative embodiment of the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

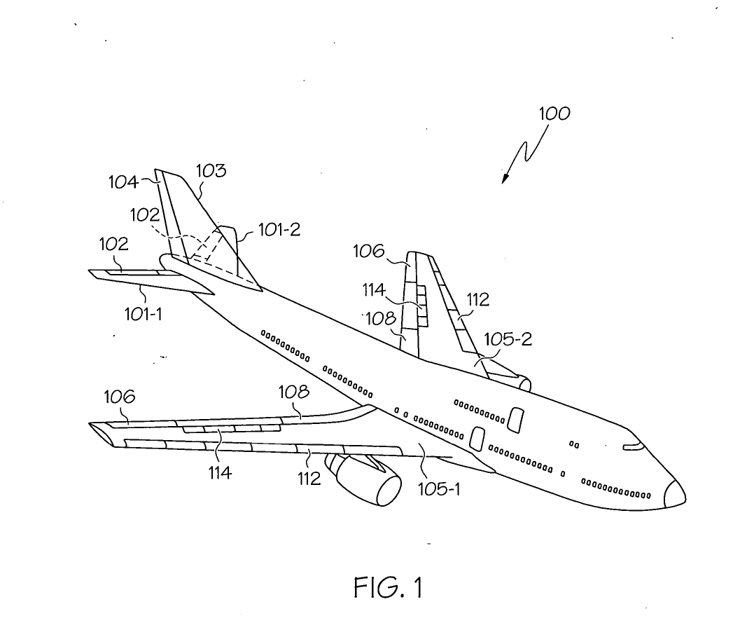

Turning first to FIG. 1, a perspective view of an exemplary aircraft is shown. In the illustrated embodiment, the aircraft 100 includes first and second horizontal stabilizers 101-1 and 101-2, respectively, a vertical stabilizer 103, and first and second wings 105-1 and 105-2, respectively. An elevator 102 is disposed on each horizontal stabilizer 101-1, 101-2, a rudder 104 is disposed on the vertical stabilizer 103, and an aileron 106 is disposed on each wing 105-1, 105-2. In addition, a plurality of flaps 108, slats 112, and spoilers 114 are disposed on each wing 105-1, 105-2. The elevators 102, the rudder 104, and the ailerons 106 are typically referred to as the primary flight control surfaces, and the flaps 108, the slats 112, and the spoilers 114 are typically referred to as the secondary flight control surfaces.

The primary flight control surfaces 102-106 control aircraft movements about the aircraft pitch, yaw, and roll axes. Specifically, the elevators 102 are used to control aircraft movement about the pitch axis, the rudder 104 is used to control aircraft movement about the yaw axis, and the ailerons 106 control aircraft movement about the roll axis. It is noted, however, that aircraft movement about the yaw axis can also be achieved by varying the thrust levels from the engines on opposing sides of the aircraft 100. It will additionally be appreciated that the aircraft 100 could include horizontal stabilizers (not shown).

The secondary control surfaces 108-114 influence the lift and drag of the aircraft 100. For example, during aircraft take-off and landing operations, when increased lift is desirable, the flaps 108 and slats 112 may be moved from retracted positions to extended positions. In the extended position, the flaps 108 increase both lift and drag, and enable the aircraft 100 to descend more steeply for a given airspeed, and also enable the aircraft 100 get airborne over a shorter distance. The slats 112, in the extended position, increase lift, and are typically used in conjunction with the flaps 108. The spoilers 114, on the other hand, reduce lift and when moved from retracted positions to extended positions, which is typically done during aircraft landing operations, may be used as air brakes to assist in slowing the aircraft 100.

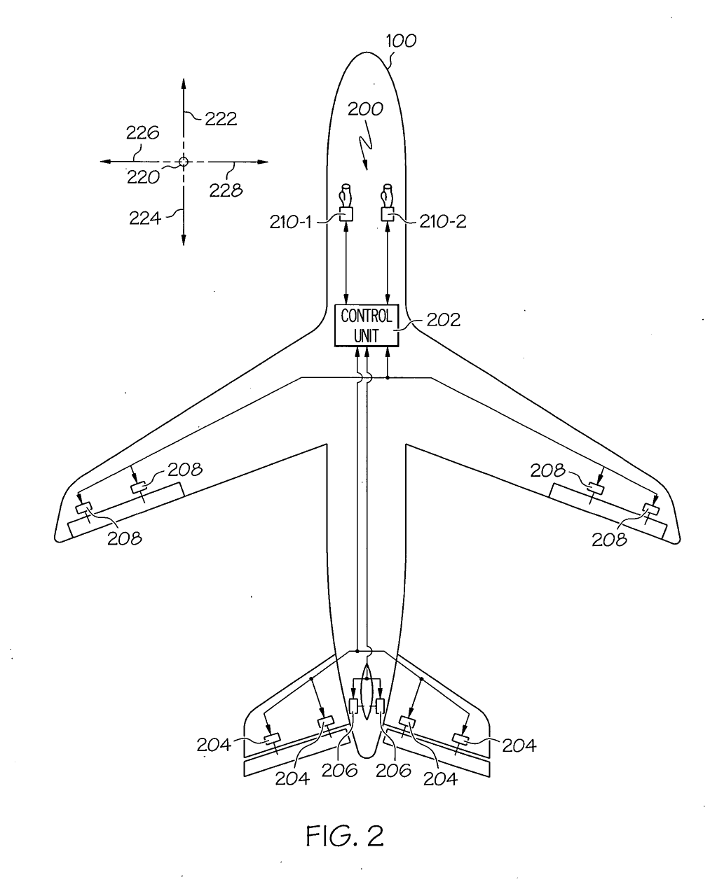

The flight control surfaces 102-114 are moved to commanded positions via a flight control surface actuation system 200, an exemplary embodiment of which is shown in FIG. 2. In the depicted embodiment, the flight control surface actuation system 200 includes one or more control units 202, a plurality of primary flight control surface actuators, which include elevator actuators 204, rudder actuators 206, and aileron actuators 208. It will be appreciated that the system 200 is preferably implemented with more than one control unit 202. However, for ease of description and illustration, only a single, multi-channel control unit 202 is depicted. It will additionally be appreciated that one or more functions of the control unit 202 could be implemented using a plurality of devices.

Before proceeding further, it is noted that the flight control surface actuation system 200 additionally includes a plurality of secondary control surface actuators, such as flap actuators, slat actuators, and spoiler actuators. However, the operation of the secondary flight control surfaces 108-114 and the associated actuators is not needed to fully describe and enable the present invention. Thus, for added clarity, ease of description, and ease of illustration, the secondary flight control surfaces and actuators are not depicted in FIG. 2, nor are these devices further described.

Returning now to the description, the flight control surface actuation system 200 may additionally be implemented using various numbers and types of primary flight control surface actuators 204-208. In addition, the number and type of primary flight control surface actuators 204-208 per primary flight control surface 102-106 may be varied. In the depicted embodiment, however, the system 200 is implemented such that two primary flight control surface actuators 204-208 are coupled to each primary flight control surface 102-106. Moreover, each of the primary flight control surface actuators 204-208 are preferably a linear-type actuator, such as, for example, a ballscrew actuator. It will be appreciated that this number and type of primary flight control surface actuators 204-208 are merely exemplary of a particular embodiment, and that other numbers and types of actuators 204-208 could also be used.

No matter the specific number, configuration, and implementation of the control units 202 and the primary flight control surface actuators 204-208, the control unit 202 is configured to receive aircraft pitch and roll commands from one or more input control mechanisms. In the depicted embodiment, the system 200 includes two input control mechanisms, a pilot input control mechanism 210-1 and a co-pilot input control mechanism 210-2. As will be described in more detail below, the pilot 210-1 and co-pilot 210-2 input control mechanisms are both implemented as flight control sticks. It will be appreciated that in some embodiments, the system 200 could be implemented with more or less than this number of flight control sticks 210. Nonetheless, the control unit 202, in response to the pitch and roll commands supplied from one or both flight control sticks 210, commands the appropriate primary flight control surface actuators 204-208 to move the appropriate primary flight control surfaces 102-106 to positions that will cause the aircraft to implement the commanded pitch or roll maneuver.

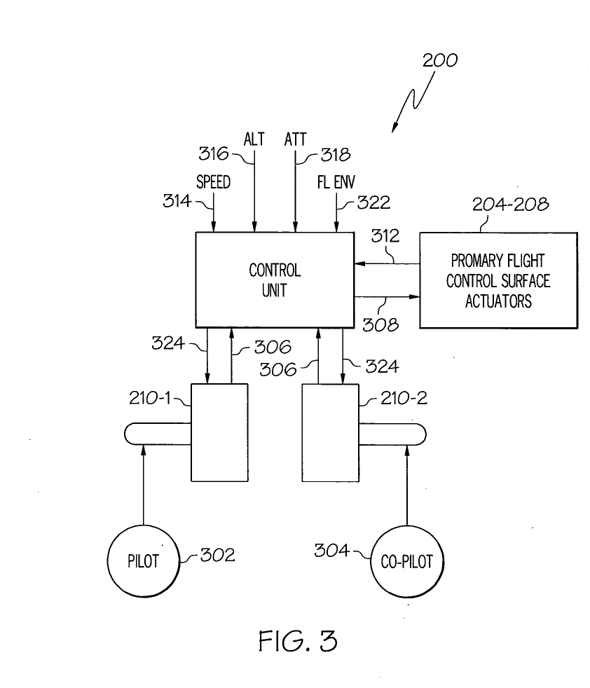

Turning now to FIG. 3, which is also a functional block diagram of the flight control surface actuation system 200 depicting portions thereof in slightly more detail, the flight control sticks 210 are each configured to move, in response to input from either a pilot 302 or a co-pilot 304, to a control position in a displacement direction. Although the configuration of the flight control sticks 210 may vary, in the depicted embodiment, and with quick reference to FIG. 2, each flight control stick 210 is configured to be movable, from a null position 220, to a control position in a forward direction 222, an aft direction 224, a port direction 226, a starboard direction 228, a combined forward-port direction, a combined forward-starboard direction, a combined aft-port direction, or a combined aft-starboard direction, and back to or through the null position 220. It will be appreciated that flight control stick movement in the forward 222 or aft 224 direction causes the aircraft 100 to implement a downward or upward pitch maneuver, respectively, flight control stick movement in the port 226 or starboard 228 direction causes the aircraft 100 to implement a port or starboard roll maneuver, respectively, flight control stick movement in the combined forward-port or forward-starboard direction, causes the aircraft 100 to implement, in combination, a downward pitch and either a port or a starboard roll maneuver, respectively, and flight control stick movement in the combined aft-port or aft-starboard direction, causes the aircraft 100 to implement, in combination, an upward pitch and either a port or a starboard roll maneuver, respectively.

Returning once again to FIG. 3, the flight control sticks 210 are each further configured to supply a flight control surface position control signal 306 to the control unit 202 that is based, at least in part, on its position. The control unit 202, upon receipt of the flight control surface position signal 306, supplies power to the appropriate primary flight control surface actuators 204-208, to move the appropriate primary flight control surface actuators 204-208 to the appropriate control surface position, to thereby implement a desired maneuver. As FIG. 3 additionally depicts, the control unit 202 also preferably receives a plurality signals representative of aircraft conditions. Although the specific number of signals, and the conditions of which each signal is representative of, may vary, in the depicted embodiment, these signals include primary flight control surface position signals 312, aircraft speed 314, aircraft altitude 316, and aircraft attitude 318. In addition, the control unit 202 is also preferably coupled to receive signal representative of aircraft operating envelope 322. It will be appreciated that one or more of these signals may be supplied from individual sensors that are dedicated to the system 200 or shared with other systems in the aircraft, or supplied via one or more data buses within the aircraft.

No matter the specific source of each signal that is supplied to the control unit 202, the control unit 202 is further operable, in response to these signals 312-318, to selectively supply one or more force feedback signals 324 to the appropriate flight control stick 210. The force feedback signals 324 are preferably variable in magnitude, based on the control position of the flight control stick 210, the aircraft conditions, as represented by each of the aircraft condition signals 312-318, and the aircraft operating envelope 324, as represented by its associated signal 322. The force feedback signals 324 supplied to the pilot flight control stick 210-1 are also preferably variable in magnitude based on the position of the co-pilot flight control stick 210-2. As will be described in more detail below, the flight control stick 210, in response to the variable force feedback control signals 324, supplies haptic feedback to the pilot 302 or co-pilot 304, as the case may be.

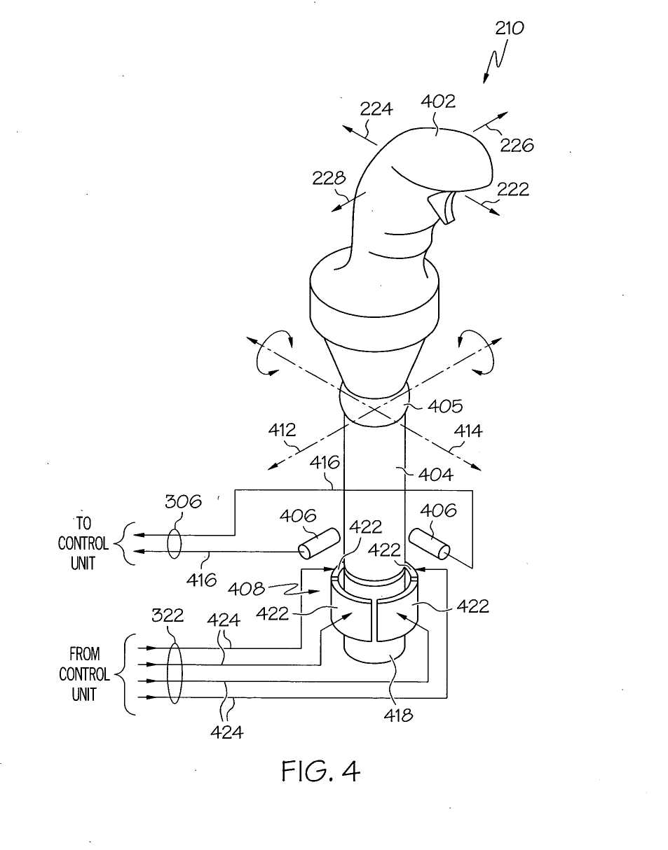

Turning now to FIG. 4, a simplified representation of one of the flight control sticks 210 is depicted and includes handle 402, a shaft 404, a plurality of displacement sensors 406, and a magnetic bearing 408. The handle 402 is the main user (pilot or co-pilot) interface, and is configured to be readily grasped by a hand. The shaft 404 is coupled to, and extends away from, the handle 402, and includes a bearing surface 405 that allows the control stick 210 to be movably mounted within a non-illustrated mount structure. In particular, the bearing surface 405 is configured so that the flight control stick 210 may be rotated about a pitch axis 412 and a roll axis 414, either alone or in combination, to thereby move the handle 402 in the forward direction 222, the aft direction 224, the port direction 226, the starboard direction 228, or combined forward-port, forward-starboard, aft-port, or aft-starboard directions. It will be appreciated that the depicted mounting arrangement is merely exemplary, and that numerous other arrangements could be implemented.

The displacement sensors 406 are orthogonally disposed to each other along the pitch 412 and roll 414 axes, and are each configured to sense the displacement of the shaft 404, relative to a reference position, along its associated axis. It will be appreciated that the reference position of the shaft 404 preferably corresponds to the null position 220 of the control stick 210. The position sensors 406 in turn each supply a position signal 416 representative of the relative displacement to the control unit 202. It is these position signals 416 that preferably constitute the flight control surface position signal 306.

The magnetic bearing 408 includes one or more magnetic bearing rotors 418 and a plurality of magnetic bearing stators 422. The magnetic bearing rotor 418 is coupled to the shaft 404 and may be implemented as either a permanent magnet or an electromagnet. If the magnetic bearing rotor 418 is implemented as an electromagnet, it is preferably constructed of a ferromagnetic material. The magnetic bearing stators 422 are each disposed adjacent to, and are each spaced apart from, the magnetic bearing rotor 418, and are each preferably implemented as electromagnets that are coupled to receive variable electrical current signals 424 from the control unit 202. It is these variable electrical current signals 424 that preferably constitute the variable force feedback signals 324. Thus, the magnetic bearing 408, upon receipt of the variable force feedback signals 324, supply a variable magnetic force to the shaft 404, and thus to the handle 402, in a direction that opposes the displacement direction of the handle 402.

In the embodiment depicted in FIG. 4, the magnetic bearing 408 is implemented with four magnetic bearing stators 422, one for each direction of flight control stick movement. It will be appreciated, however, that the magnetic bearing 408 could be implemented with, for example, two orthogonally disposed magnetic bearing stators 422. Moreover, the magnetic bearing 408 depicted in FIG. 4 is implemented as a radial magnetic bearing. It will be appreciated, however, that is could additionally be implemented as a conical magnetic bearing, if needed or so desired.

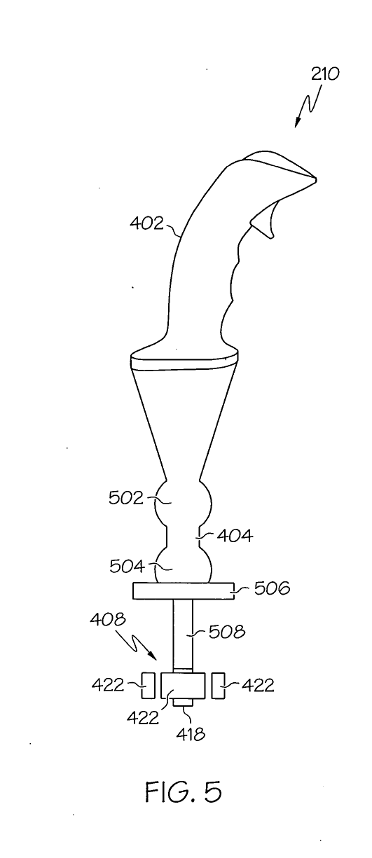

As was previously alluded to, the configuration of the control sticks 210 may vary. For example, and as depicted in FIG. 5, the control shaft 404 may be configured with two bearing surfaces 502, 504. The first bearing surface 502 is configured to allow the control stick 210 to be movably mounted within a non-illustrated mount structure. The second bearing surface 504 is slidingly or rotationally disposed within a non-illustrated opening or depression in a plate 506, or other similar structure. A second shaft 508 is coupled to, and extends from the plate 506.

With configuration depicted in FIG. 5, as the handle 402 is moved, the first shaft 404 rotates about either the pitch 412 or roll 414 axis (not shown in FIG. 5). This rotation of the first shaft 404 results in translation of the plate 506, and concomitantly translation of the second shaft 508. This particular configuration may be advantageous when the magnetic bearing 408 is implemented as a radial bearing, since the magnetic bearing rotor 418 will, at least substantially, always be parallel to an axis 512 that extends through the second shaft 508 when the flight control stick 210 is in its null position. This can simplify overall control.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An aircraft flight control surface actuation haptic feedback system, comprising:
a flight control stick adapted to receive an input force supplied by a pilot and configured, upon receipt of the input force, to move to a control position in a displacement direction;
a control unit adapted to receive signals representative of aircraft speed, aircraft altitude, aircraft attitude, and aircraft flight envelope and operable, in response thereto, to supply a plurality of independent variable force feedback signals; and
a magnetic bearing including a rotor and a plurality of stators, the magnetic bearing rotor coupled to the flight control stick, each magnetic bearing stator disposed adjacent to, and spaced apart from, the magnetic bearing rotor, each magnetic bearing stator coupled to receive one of the independent variable force feedback signals and operable, in response thereto, to supply a variable magnetic feedback force to the magnetic bearing rotor that urges the magnetic bearing rotor in a direction that opposes the displacement direction of the flight control stick.

2. The system of claim 1, wherein:
the flight control stick is further configured, upon movement thereof to the control position, to supply a flight control surface position control signal based at least in part on the control position; and
the control unit is coupled to receive the flight control surface position control signal from the flight control stick and is further operable, in response thereto, to supply one or more flight control surface position commands.

3. The system of claim 2, further comprising:
one or more flight control stick position sensors configured to sense the control position of the flight control stick and operable to supply the flight control surface position control signal.

4. The system of claim 2, wherein the control unit is further responsive to the flight control surface position control signal to supply the plurality of independent variable force feedback signals.

5. The system of claim 1, wherein the control unit is further adapted to receive signals representative of aircraft flight control surface positions.

6. (canceled)

7. The system of claim 1, further comprising:
a second flight control stick adapted to receive an input force supplied by a second pilot and configured, upon receipt of the input force, to (i) move to a control position in a displacement direction and (ii) supply a flight control surface position control signal based at least in part on the control position,
wherein the control unit is coupled to receive the flight control surface position control signal from the second flight control stick and is further operable, in response thereto, to supply the plurality of independent variable force feedback signals.

8-10. (canceled)

11. An aircraft flight control surface actuation system, comprising:
a flight control stick adapted to receive an input force supplied by a pilot and configured, upon receipt of the input force, to (i) move to a control position in a displacement direction and (ii) supply a flight control surface position control signal based at least in part on the control position to which the flight control stick is moved;
a control unit coupled to receive (i) the flight control surface position control signal and (ii) signals representative of aircraft speed, aircraft altitude aircraft attitude and aircraft flight envelope and operable, in response thereto, to (i) supply one or more flight control surface position commands and (ii) supply a plurality of independent variable force feedback signals; and
a magnetic bearing including a rotor and a plurality of stators, the magnetic bearing rotor coupled to the flight control stick, each magnetic bearing stator disposed adjacent to, and spaced apart from, the magnetic bearing rotor, each magnetic bearing stator coupled to receive one of the independent variable force feedback signals and operable, in response thereto, to supply a variable magnetic feedback force to the magnetic bearing rotor that urges the magnetic bearing rotor in a direction that opposes the displacement direction of the flight control stick.

12. The system of claim 11, further comprising:
one or more flight control stick position sensors configured to sense the control position of the flight control stick and operable to supply the flight control surface position control signal.

13. The system of claim 12, wherein the control unit is further responsive to the flight control surface position control signal to supply the plurality of independent variable force feedback signals.

14. The system of claim 11, wherein the one or more signals representative of aircraft flight conditions include one or more signals representative of aircraft flight control surface positions.

15. (canceled)

16. The system of claim 11, further comprising:
a second flight control stick adapted to receive an input force supplied by a second pilot and configured, upon receipt of the input force, to (i) move at least a portion thereof to a control position in a displacement direction and (ii) supply a flight control surface position control signal based at least in part on the control position,
wherein the control unit is coupled to receive the flight control surface position control signal from the second flight control stick and is further operable, in response thereto, to supply the plurality of independent variable force feedback signals.

17-18. (canceled)

19. An aircraft flight control surface actuation system, comprising:
a flight control stick adapted to receive an input force supplied by a pilot and configured, upon receipt of the input force, to move to a control position in a displacement direction
one or more flight control stick position sensors configured to sense the control position of the flight control stick and operable to supply a flight control surface position control signal based at least in part on the sensed control position;
a control unit coupled to receive (i) the flight control surface position control signal, (ii) one or more signals representative of aircraft conditions, and (iii) a signal representative of aircraft operational envelope, and operable, in response thereto, to (i) supply one or more flight control surface position commands and (ii) supply a plurality of independent variable force feedback signals; and
a magnetic bearing including a rotor and a plurality of stators, the magnetic bearing rotor coupled to the flight control stick, each magnetic bearing stator disposed adjacent to, and spaced apart from, the magnetic bearing rotor, each magnetic bearing stator coupled to receive one of the independent variable force feedback signals and operable, in response thereto, to supply a variable magnetic feedback force to the magnetic bearing rotor that urges the magnetic bearing rotor in a direction that opposes the displacement direction of the flight control stick.

20. (canceled)
